(19) United States
(12) Patent Application Publication
(10) Pub. No.: US 2017/0103337 A1
(43) Pub. Date: Apr. 13, 2017

(54) SYSTEM AND METHOD TO DISCOVER MEANINGFUL PATHS FROM LINKED OPEN DATA

(71) Applicant: International Business Machines Corporation, Armonk, NY (US)

(72) Inventors: Feng Cao, ShangHai (CN); Yuan Ni, ShangHai (CN); Qiong K. Xu, ShangHai (CN); Hui J. Zhu, ShangHai (CN)

(21) Appl. No.: 14/878,407

(22) Filed: Oct. 8, 2015

(51) Int. Cl. G06N 99/00; G06N 5/02; G06F 17/30

(52) U.S. Cl. CPC G06N 99/005; G06F 17/3053; G06N 5/02

(57) ABSTRACT

A method, a system and a computer program product for searching a knowledge base and finding top-k meaningful paths for different concept pairs input by a user in linked open data utilizing the degree of association between concepts as the weight of the two concepts in a knowledge graph and to find the top-k shortest path as meaningful paths. A large corpus is used to train the association of different concept pairs. A deep learning based framework is used to learn a concept vector to represent the concept and the cosine similarity of the concept vector and an input concept vector indicating the degree of association of the vectors as the weight of these two concepts in the knowledge graph. The top-k meaningful paths are determined based on the weights and the shortest paths are provided for use by users as the meaningful paths.

### FIELD

The present invention generally relates to a method, a system, and a computer program product of finding top-k meaningful paths when searching a knowledge base for different concept pairs in linked open data in response to a user based request.

### BACKGROUND

Searching a knowledge base to enable a user to find closely related concepts or nodes in the knowledge base is important. Finding the shortest paths, and therefore most relevant paths, between two nodes in the knowledge base is a fundamental problem. The present invention proposes a system and method to solve this problem.

There is always a large number of paths between nodes with length smaller than k between two instance nodes. For example, to find paths between http://dbpedia.org/resource/Barack_Obama and http://depedia.org/resource/Bill_Clinton, results in more than 20,000 paths (no longer than 4 steps) which may be difficult for users to find the particular relationship they are seeking. The present invention discloses a system and method to find the top-k meaningful paths for users.

The top-k shortest path distance queries on knowledge graphs are useful in a wide range of important applications such as network aware searches and link prediction. The shortest-path distance between vertices in a network is a fundamental concept in graph theory. For example, because the distances between vertices indicate the relevance among the vertices, they can identify other users or content that best matches a user's intent in searches.

Linked open data is a valuable knowledge base in cognitive computing. Cognitive computing involves self-learning systems that use data mining, pattern recognition, and natural language processing to mimic the way human brains work.

Knowledge base (e.g., DBpedia) is widely used in cognitive computing, such as question/answering, decision making. When a machine delivers an answer or an automatic decision relating to two concepts, the user may need to know the reason how the decision is obtained, i.e., the relationship between the answer/decision and the question/scenario.

An existing method of finding paths tries to find all paths between vertices. The RelFinder method will return paths according to the sequence of found paths during the search. It will discard the paths which require longer times to find. Another method is to show the paths in clusters by combining the paths whose intermediate nodes belong to the same category. There is also a prior method to set the weight of the path according to the degree of the source and target node. A node having a larger degree will have a smaller weight. This method prefers specific paths. However, the specific path may not be meaningful and interesting to users. None of these prior methods consider the context of the nodes in the corpus.

Methods of finding top-k meaningful paths for different concept pairs in linked open data is known in the prior art. We use graph searching algorithms which are the A* algorithm or the BiBFS (bidirectional breath first search) algorithm, which are described hereinafter. The prior art also discloses the method of learning a vector to represent a concept using a large corpus of data and measuring the association relationship between the concepts.

However, in the present invention the degree of association between nodes is used as the weight of the two concepts in the pair in a knowledge graph in order to compute the top-k shortest paths as the meaningful paths. Such an arrangement is not disclosed in the prior art.

### SUMMARY

Knowledge bases are widely used in cognitive computing. Users may need to know the relationship between the results and the query posed. Normally, there are many paths between two nodes or concepts in the knowledge base. The paths connecting the concepts in the knowledge base could be used to explain the relationship. Therefore, a fundamental problem overcome by this invention is finding the top-k meaningful paths among the many paths between two nodes in the knowledge base.

In one aspect, the present invention provides a method, system and computer program product for finding top-k meaningful paths for different concept pairs searched in linked open data responsive to a user search request, utilizing the degree of association of pairs of concepts as the weight of the two concepts in a knowledge graph and to compute top-k shortest paths as meaningful paths. The top-k meaningful paths are the closest related searched concepts found in the knowledge base.

If two concepts always appear in the similar context, these two concepts have a stronger association and therefore the edges between the two concepts are more meaningful and interesting to users.

A large corpus is used to train the search system to learn the association of different concept pairs or vectors. A deep learning based framework is used to learn a vector representing the concept. The cosine similarity of two vectors indicates the degree of association of the vectors. The degree of association is the weight of these two concepts in the knowledge graph. Then, when searching a knowledge base the top-k shortest paths are determined based on the weights and these paths are delivered to users as the top-k meaningful paths. The shortest or most meaningful paths are the closest relationship between concept pairs in the knowledge base being searched.

The system and method further searches an unsupervised training knowledge base to find the top-k meaningful paths in a novel manner described below.

In a further aspect of the invention, a weighting strategy used to find the top-k shortest paths. Meaningful paths are found from knowledge bases where the association between the edges in the knowledge base are the weights assigned in the knowledge graph. A concept vector based method measures the similarity between paired concepts.

In addition, a neural network is used to train the model to measure the context similarity of two nodes in the knowledge graph, and the measure is used to determine the weights of the edges. The resulting weighting can find paths that connect the nodes with more similar contexts which are more meaningful to a user.

The objects, features, and advantages of the present disclosure will become more clearly apparent when the following description is taken in conjunction with the accompanying drawings.

### BRIEF DESCRIPTION OF THE DRAWINGS

FIG. 1 is a flowchart of an overall method for practicing the invention.

FIG. 2 is a flowchart of a method for searching for closest matches of concepts to be searched.

FIG. 3 is a schematic block diagram of a computer system server for practicing the invention.

FIG. 4 depicts a system architecture for practicing the present invention.

FIG. 5 is a schematic representation of a neural network based method to generate the vector representation of a concept.

FIG. 6 is an example of an article from Wikipedia.

FIG. 7A is a schematic representation of a CBOW (Continuous Bags-of-Words) model for learning to generate the vector representation of each concept.

FIG. 7B is a schematic representation of a Skip Gram Model for deep learning to generate the vector representation of each concept.

FIG. 8 depicts an example where a concept is treated as a single unit.

FIG. 9 shows the results of applying the invention to a specific example.

### DETAILED DESCRIPTION

In the following discussion, a great amount of concrete details are provided to help thoroughly understand the present invention. However, it is apparent to those of ordinary skill in the art that even though there are no such concrete details, the understanding of the present invention can not be influenced. In addition, it should be further appreciated that any specific terms used below are only for the convenience of description, and thus the present invention should not be limited to only use in any specific applications represented and/or implied by such terms.

Further, the drawings referenced in the present application are only used to exemplify typical embodiments of the present invention and should not be considered to be limiting the scope of the present invention.

It is understood in advance that although the present disclosure includes a detailed description of search engines, implementation of the teachings recited herein are not limited to a particular search engine environment. Rather, embodiments of the present invention are capable of being implemented in conjunction with any other type of computing environment now known or later developed.

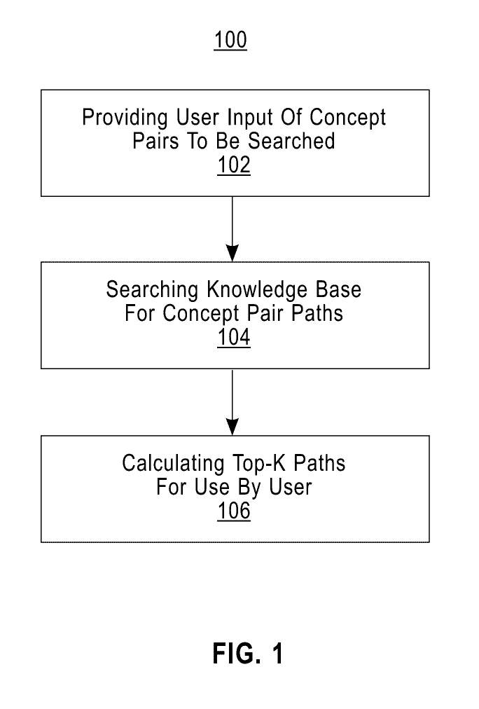

FIG. 1 shows a flowchart of an overall method for practicing the invention 100 which will described in more detail below. In FIG. 1 a user inputs concept pairs to be searched by a search engine 102. A search engine searches a knowledge base for each inputted concept pair path 104. The top-k paths from all of the pairs uncovered in the search are provided as the results for use by a user 106.

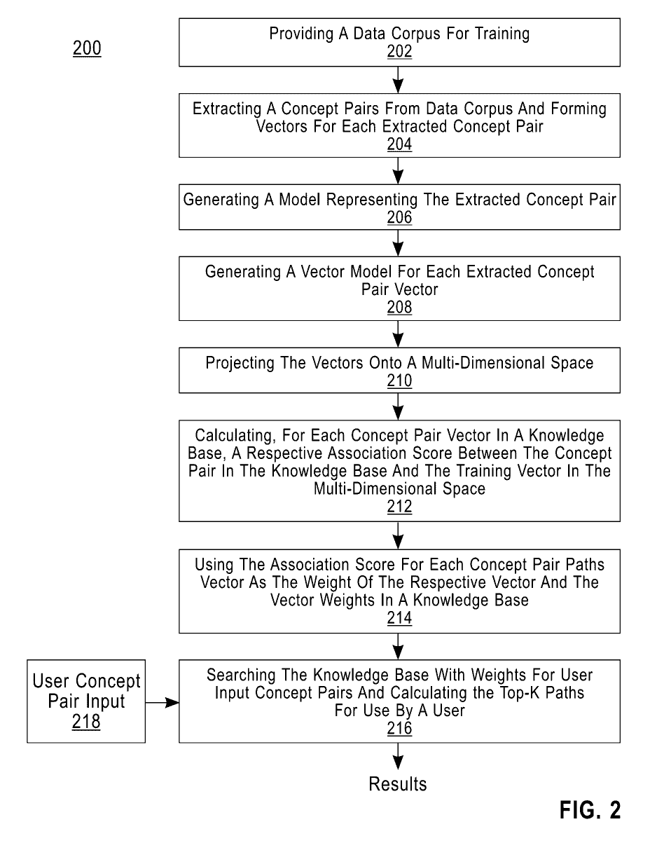

FIG. 2 shows a flowchart of the search operation 200 using a graph search algorithm for finding closest matches of concept pairs to be searched.

The following definitions are provided in order to better understand the method:
Concept: is considered as a node in the knowledge base. For instance, in the example below, Bill_Clinton is a concept.
Edge: in the knowledge base, there is an edge to connect a pair of concepts.
Vector: A vector is an element of the real coordinate space, and normally we use X=[x_1, x_2, . . . , xn] to indicate a n-dimensional vector. Here, the vector is used to represent a concept such that the association of two concepts could be calculated by the dot product of the two corresponding vectors. For example, given two concepts X and Y, and their corresponding vectors are [x_1, x_2, . . . , x_n] and [y_1, y_2, . . . , y_n], the association of concept X and Y could be calculate by the dot product of the two vectors. i.e. x_1*y_l+x_2*y_2+ . . . +x_n*y_n. The association of concept X and Y is treated as the weight for the edge that connects X and Y. The vector representation for each concept is generated by a neural network based method.

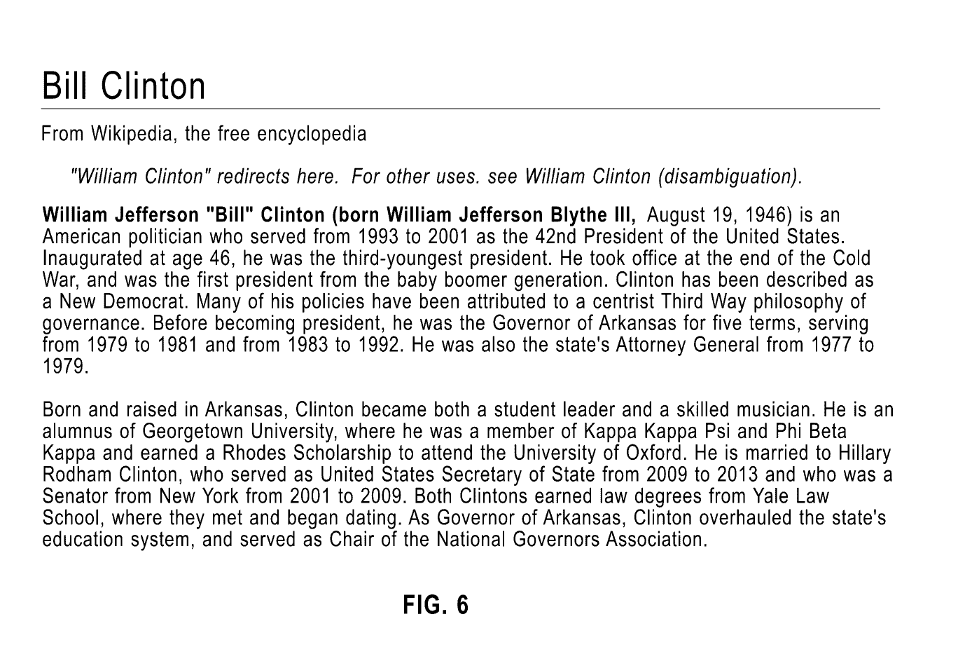

In order to search for closest matches of concept to be searched, a data corpus is provided in step 202. We use the wikipedia as the data corpus as it contains all concepts in the DBpedia and the occurrence context of these concepts. Each wikipedia page has a corresponding concept in the DBpedia. In step 204 each concept and its context from the data corpus extracted. For example, FIG. 6 shows the article for Bill Clinton in the wikipedia. The terms highlighted in blue is the wikilink (hyperlink) which is a link to another wikipedia page, i.e. concept. For example, the “Governor of Arkansas” is a wikilink pointing to the wikipedia page “Governor of Arkansas” which corresponds to the concept “Governor of Arkansas”. Thus, the Governor of Arkansas” is the occurrence of the concept “Governor of Arkansas” and the text around it is the context, i.e. “Before becoming president, he was the . . . for five terms, serving from 1979 to”.

In step 206 a vector representation is generated for each concept using a neural network based method. In step 206 the input is a collection of concepts and its context. A deep learning based method/neural network based method is used to generate the vector representation of each concept. The output is the vector representation for each concept. These vectors are stored and we call them concept vector models.

Now, given the knowledge base, we already have the vector representation for each concept, i.e. node in the knowledge graph. Next, in step 208, we will calculate the weight for each edge in the knowledge graph. Given an edge that connects two concepts X and Y, the weight of the edge is the association between the concepts X and Y, which is the dot product of the corresponding vectors of X and Y. Thus, given an edge connecting the concepts X and Y and calling and reading the vector representations of X and Y from the precomputed concept vector models, we obtain a knowledge base with associated weights on each edge 210. In step 214, given a pair of input concepts 212, the top-k shortest paths between the concepts is calculated using a graph search algorithms such as:
A* algorithm
F=g+h, the most important is how to set h
vector(c) * vector(target), where c is the current node and
BiBFS (bidirectional breath first search)
Try to expand the nodes with less neighbors first

An A* algorithm is described, for example, at https://en.wikipedia.org/wiki/A*_searchalgorithm which is incorporated herein by reference.

For the function F=g+h we need to provide a heuristic strategy to estimate h. Suppose the current search node is c, and the target node is “target”, then using vector(c)*vector (target) to estimate h where vector(c) is the vector representation of concept c and * means the dot product.

The top-k shortest paths are presented as the results 216 for use by a user.

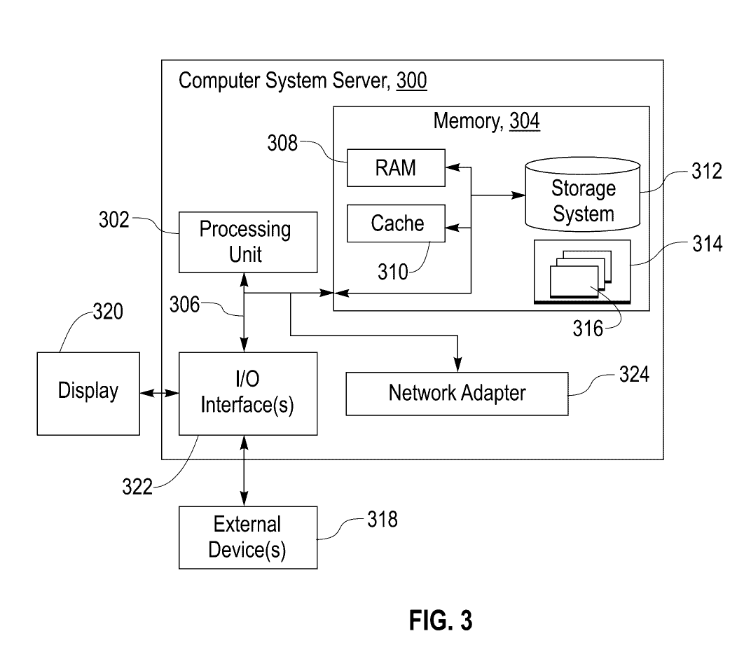

Referring to FIG. 3, computer system/server 300 can be described in the general context of computer system-executable instructions, such as program modules, being executed by a computer system. Generally, program modules can include routines, programs, objects, components, logic, data structures, and so on that perform particular tasks or implement particular abstract data types. computing environment, program modules can be located in both local and remote computer.

As shown in FIG. 3, computer system/server 300 is shown in the form of a general-purpose computing device. The components of computer system/server 300 can include, but are not limited to, one or more processors or processing units 302, a system memory 304, and a bus 306 that couples various system components including system memory 304 and processor 302.

Bus 306 represents one or more of any of several types of bus structures, including or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA bus, Video Electronics Standards Association (VESA) local bus, and Peripheral Component Interconnects (PCI) bus.

Computer system/server 300 typically includes a variety of computer system readable media. Such media can be any available media that is accessible by computer system/server 300, and it includes both volatile and non-volatile media, removable and non-removable media.

System memory 304 can include computer system readable media in the form of volatile memory, such as random access memory (RAM) 308 and/or cache memory 310. Computer system/server 300 can further include other removable/non-removable, volatile/non-volatile computer system storage media. By way of example only, storage system 312 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 306 by one or more data media interfaces. As will be further depicted and described below, memory 304 can include at least one program product having a set (e.g., at least one) of program modules that are configured to carry out the functions of embodiments of the invention.

Program/utility 314, having a set (at least one) of program modules 316, can be stored in memory 304 by way of example, and not limitation, as well as an operating system, one or more application programs, other program modules, and program data. Each of the operating system, one or more application programs, other program modules, and program data or some combination thereof, can include an implementation of a networking environment. Program modules 316 generally carry out the functions and/or methodologies of embodiments of the invention as described herein.

Computer system/server 300 can also communicate with one or more external devices 318 such as a keyboard, a pointing device, a display 320, etc.; one or more devices that enable a user to interact with computer system/server 300; and/or any devices (e.g., network card, modem, etc.) that enable computer system/server 300 to communicate with one or more other computing devices. Such communication can occur via Input/Output (I/O) interfaces 322. Still yet, computer system/server 300 can communicate with one or more networks such as a local area network (LAN), a general wide area network (WAN), and/or a public network (e.g., the Internet) via network adapter 324. As depicted, network adapter 324 communicates with the other components of computer system/server 300 via bus 306. It should be understood that although not shown, other hardware and/or software modules can be used in conjunction with computer system/server 300. Examples, include, but are not limited to: microcode, device drivers, redundant processing units, external disk drive arrays, RAID systems, tape drives, and data archival storage systems, etc.

Having described an implementation of the invention in terms of a general-purpose computing device, the following description describes an implementation using a graph search algorithm with a neural network based language model conducting an unsupervised learning to train a model to measure the similarity of two vectors in a knowledge graph.

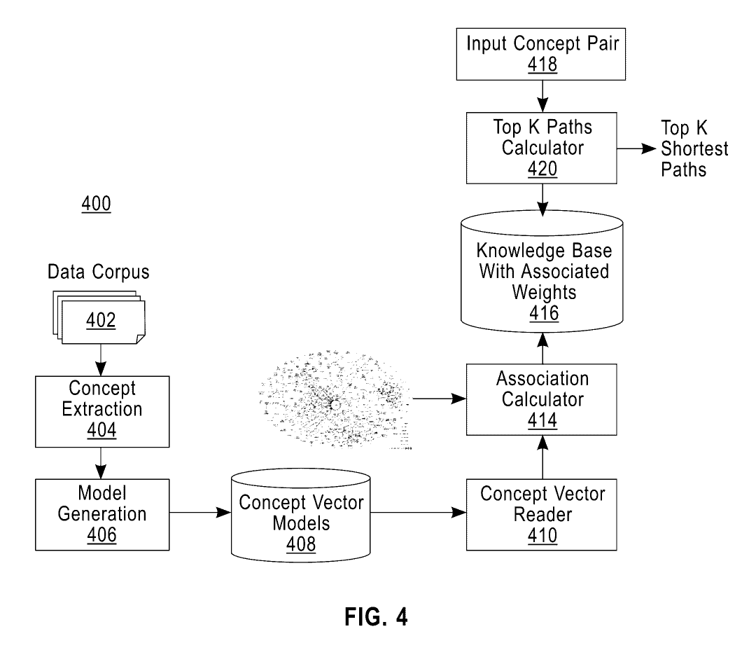

FIG. 4 depicts a system architecture 400 for finding top-k meaningful paths for different concept pairs linked in open data utilizing the degree of association between the concept pair as the weight of the two concepts in a knowledge graph. The resulting weighting finds paths that connect the nodes with most similar contexts. Nodes with similar contexts are more meaningful to a user.

Data corpus 402, Concept Extraction 404, and Model Generation 406 are for generating the vector representation for each concept.

It is necessary to prepare a data corpus 402. Here, we use the wikipedia as the data corpus as it contains all concepts in the DBpedia and the occurrence context of these concepts. Each wikipedia page has a corresponding concept in the DBpedia 402. The concept extraction 404 extracts each concept and its context from the data corpus. For example, FIG. 6 shows an article for Bill Clinton in the wikipedia. The terms highlighted in blue is the wikilink (hyperlink) which is a link to another wikipedia page, i.e. concept. For example, the “Governor of Arkansas” is a wikilink pointing to the wikipedia page “Governor of Arkansas” which corresponds to the concept “Governor of Arkansas”. Thus, the Governor of Arkansas” is the occurrence of the concept “Governor of Arkansas” and the text around it is the context, i.e. “Before becoming president, he was the . . . for five terms, serving from 1979 to . . . ”. The Model Generation component 406 generates the vector representation for each concept using a neural network based method. The input for the Model Generation component is a collection of concepts and its context. The output of the Model Generation component is the vector representation for each concept. These vectors are stored and are referred to as concept vector models 408.

Now, given a knowledge base 412, there is the vector representation for each concept, i.e. node, in the knowledge graph. Then we calculate the weight for each edge in the knowledge graph. This is performed by the Association Calculator component 414. Given an edge that connects two concepts X and Y, the weight of the edge is the association between the concepts X and Y, which is the dot product of the corresponding vectors of X and Y. Thus, given an edge connecting the concepts X and Y, the Association Calculator 414 will call the Concept Vector Reader 410 to read the vector representations of X and Y from the precomputed concept vector models 408. Afterwards, there is a knowledge base with associated weights 416 on each edge. Finally, given a pair of input concepts 418, the top-k paths calculator 420 will find the top-k shortest paths using a graph search algorithm product such as:
A* algorithm
F=g+h, the most important is how to set h
vector(c) * vector(target), where c is the current node and
BiBFS (bidirectional breath first search)
Try to expand the nodes with less neighbors first

An A* algorithm is described, for example, at https://en.wikipedia.org/wiki/A*_searchalgorithm which is incorporated herein by reference.

For the function F=g+h we need to provide a heuristic strategy to estimate h. Suppose the current search node is c, and the target node is “target”, then using vector(c)*vector (target) to estimate h where vector(c) is the vector representation of concept c and * means the dot. The calculated top-k shortest paths are presented for use by a user.

The above-described architecture as well as the previously described method and the method below may be implemented in a general-purpose computing device, for example, such as the type shown in FIG. 3. Various elements may be implemented in hardware, software, firmware, or a combination thereof.

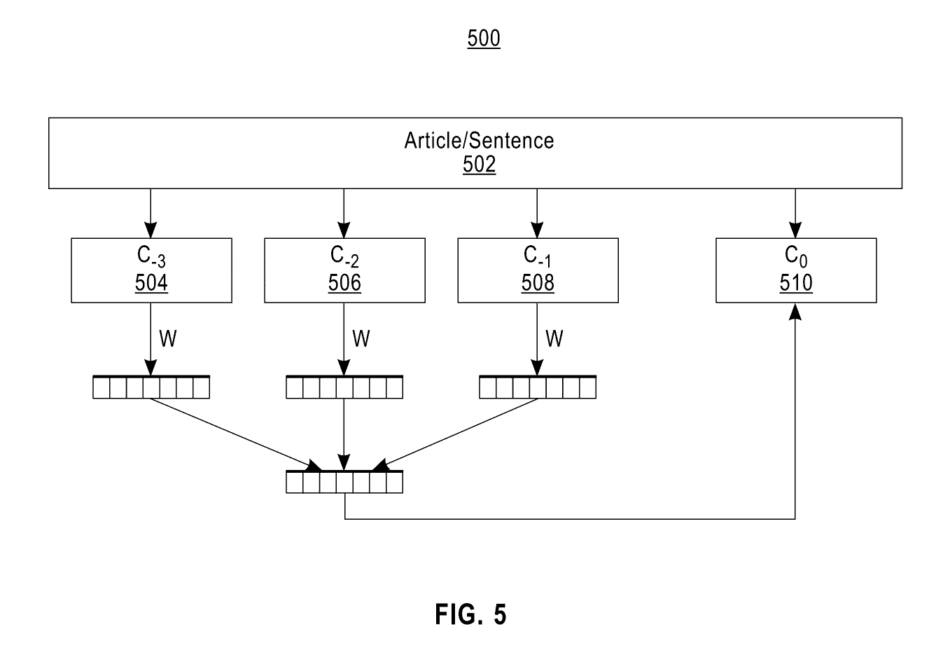

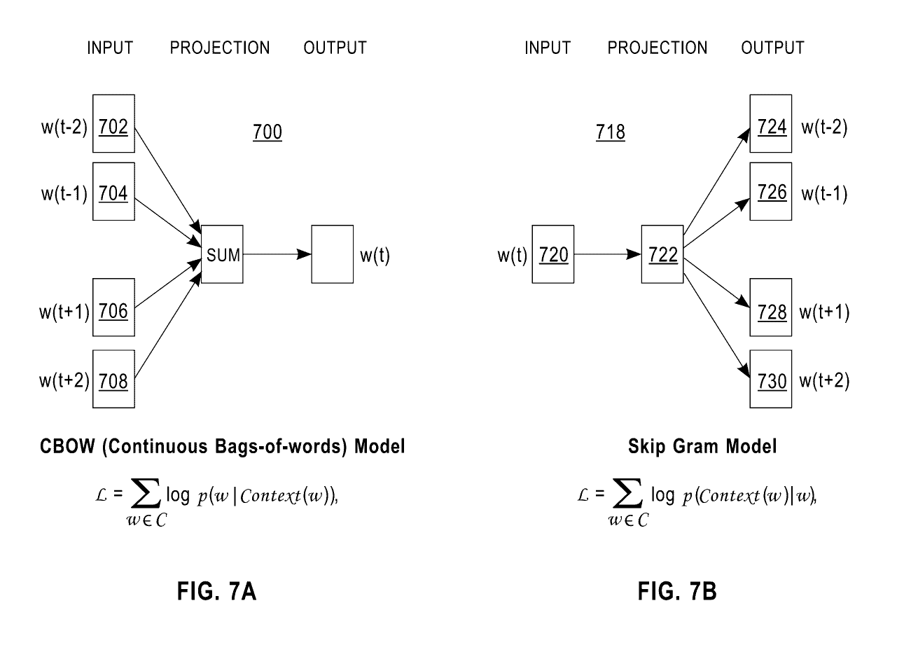

Referring to FIG. 5, there is shown a neural network based method to generate a concept vector 500. Starting with an article/sentence 502, the method uses the vectors of concepts C₋₃ 504, C₋₂ 506, C₋₁ 508, etc, in the context to predict the vector of the current concept C₀ 510. In order to implement the method, various kinds of neural network structures could be used. FIGS. 7A and 7B, described below, show two examples of the kinds of neural network structures that could be used for the concept vector generation. In the examples we use the Wikipedia articles as the data corpus and DBpedia as the linked open data knowledge base. Of course, other data corpus and knowledge bases can be used, particularly those related to specific fields of inquiry.

The articles from Wikipedia provide valuable context of the concepts in Linked open data. The wikilink to another concept is considered as the occurrence of a concept and the text surrounding the wikilink is the context of the concept. For example, given the article in FIG. 6, the “Governor of Arkansas” is considered as a concept and “Before becoming president, he was the . . . for five terms, serving from 1979 to” is considered as the context. The concept extraction component 404 extracts the concepts and its context from the data corpus.

A first arrangement, referred to as the CBOW method for finding top-k meaningful paths uses deep learning to generate concept vectors 700 is shown in FIG. 7A. In a CBOW (Continuous Bags-of-Words) Model there are three layers of the model. The input layer is the vectors of each concept in the context. Given the current concept w(t), suppose we use a window size C to select the context, then the concepts in the context are w(t−c), w(t−c+1), w(t−2), w(t−1), w(t+1), w(t+2), . . . , w_(t+c). Then the input is the vectors of these concepts, i.e. v(w (t−c)), v(w(t−c+1)), . . . , v(w(t−1)), v(w(t+1)), v(w(t+2)), v(w(t+c)). The middle layer is the projection layer which is just the sum of all vectors from the input layer which is shown as follows.

$${x}_{w} = {\sum }_{i = 1}^{2 c} v ( {Context ( w )}_{i} )$$

Finally, the output layer is the vector of the current concept v(w(t)). The parameters of this network are the vectors of each concept. The vector of each concept is obtained by maximizing

the following likelihood function.

$$ℒ = {\sum }_{w ∈ C} log p ( w \vert Context ( w ) ) ,$$

A second arrangement, referred to as the Skip Gram method for finding top-k meaningful paths uses deep learning to generate concept vectors 700 is shown in FIG. 7B. The goal of the method is given the current concept w(t), to maximize the probability of its context concepts, i.e. w(t−2), w(t_1), w(t+1), w(t+2). Thus the vector of each concept is obtained by maximizing the likelihood function as follows.

$$ℒ = {\sum }_{w ∈ C} log p ( Context ( w ) \vert w ) ,$$

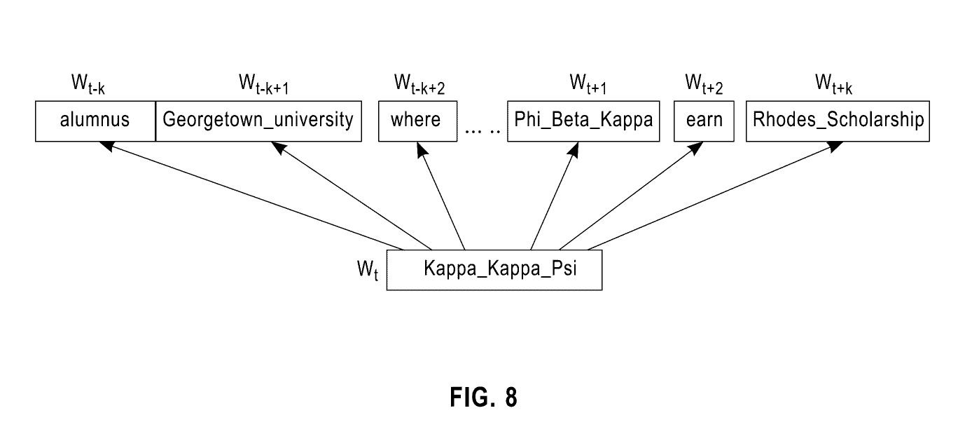

In an alternative method of deep learning to generate concept vector the concept is treated as a single unit as shown in FIG. 8.

In the example shown in FIG. 8, consider the sentence
He is an alumnus of Georgetown University, where he was a member of Kappa Kappa Psi and Phi Beta Kappa and earned a Rhodes Scholarship to attend University of Oxford.

The concept Kappa_Kappa Psi Wₜ is associated with each word vector alumnus Wₜ₋ₖ, Georgetown_University Wₜ₋ₖ₊₁, where Wₜ₋ₖ₊₂, . . . , Phi_Beta_Kappa Wₜ₊₁, earn Wₜ₊₂, and Rhodes Scholarship Wₜ₊ₖ. Using Wikipedia as the corpus, we obtain the vector for approximately 7 million terms which includes 3 million words and 4 million concepts.

Top-K Path Calculator

Given the association between the pair of concepts, we use the associations to assign the weight on each edge. Then, a graph search algorithm can be used to find the top-k shortest paths for two nodes.
F=g+h, the most important is how to set h
vector(c) * vector(target), where c is the current node and
[symbol] BiBFS (bidirectional breath first search)
Try to expand the nodes with less neighbors first

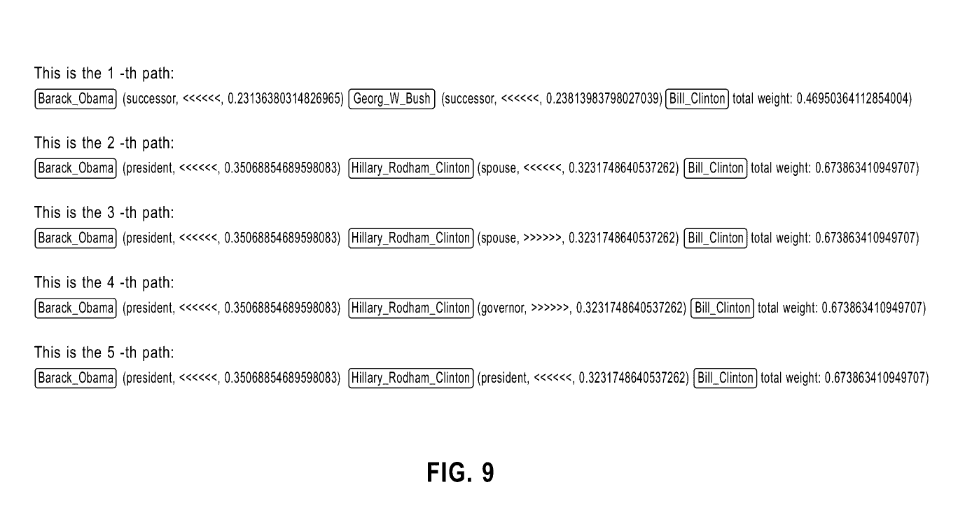

FIG. 9 shows the results of applying the invention to finding paths between http://dbpedia.org/resource/BarackObama and http://depedia.org/resource/Bill_Clinton.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While there has been described and illustrated a method and system for finding top-k meaningful paths for different input concept pairs to be searched in linked open data utilizing degree of association of vectors representing the concept pairs as the weight of the two concepts in a knowledge graph to compute top-k shortest path as meaningful paths, it will be apparent to those skilled in the art that modifications and variations are possible without deviating from broad scope of the invention which shall be limited solely by the scope of the claims appended hereto.

1. A system for searching a knowledge base for finding top-k meaningful paths between concepts in linked open data in response to input concept pairs based on a user search request, comprising:
a data corpus containing concept pairs;
a processing unit comprising:
a concept extraction module to search and extract concept and its context from said data corpus;
a model generation module to generate a vector representation for each extracted concept;
a concept vector model storage which stores a vector representation from said module generation module;
a concept vector reader which stores vector representation of concept pairs from the concept vector module;
a knowledge base;
said processing unit further including:
an association calculator, using each concept vector representation from said concept vector reader and search results of the knowledge base in response to the input concept pairs, calculating an association score for each concept vector pair and assigning each score as the weight of a vector connecting the respective concept pair;
storage for storing a knowledge base with associated weights, the weights being associated with each respective concept; and
a top-k paths calculator for using the stored association score of each respective concept vector pair to generate top-k meaningful paths of an input concept pair input to the system.

2. The system as set forth in claim 1, where said model generation module comprises a neural network based language model.

3. The system as set forth in claim 1, further comprising a deep learning module in said processing unit for generating a concept vector model representing each concept pair and the cosine similarity of the concept vector model and an input concept vector represents the degree of association of the concept vector model and the input concept vector, the degree of association being the weight of the concept pair.

4. The system as set forth in claim 3, where top-k meaningful paths calculator computes the top-k shortest paths based on the weight of the concept pairs for providing the top-k meaningful paths for use by a user.

5. The system as set forth in claim 3, wherein the deep learning module is a Continuous Bags-of-Words model.

6. The system as set forth in claim 3, wherein the deep learning module is a Skip Gram Model.

7. The system as set forth in claim 1, wherein said data corpus comprises Wikipedia articles and said knowledge base is DBpedia.

8. A computing device implemented method for searching a knowledge base for finding top-k meaningful paths between concepts in linked open data in response to concept pairs based on user request, comprising:
providing a data corpus containing concept pairs;
searching and extracting concepts and its context from the data corpus;
generating a vector representation for each extracted concept;
calculating the weight for each edge in a knowledge graph given an edge and using a vector representation from a precomputed concept vector model, calculating the weight of the edge for storage in a knowledge base with associated weights for each given edge;
calculating the top-k paths between a pair of input concepts using the knowledge base with associated weights;
providing the top-k shortest paths for use by a user.

9. The method as set forth in claim 8, where said generating a vector representation uses a neural network based language model.

10. The method as set forth in claim 8, further comprising learning a vector by deep learning a vector representing a concept vector model and the cosine similarity of each concept vector model and input concept vectors represents the degree of association of each concept vector model and input concept vector, the degree of association being the weight of the concept pair.

11. The method as set forth in claim 10, where top-k shortest paths are generated based on the weight of the concept pairs.

12. The method as set forth in claim 10, wherein the deep learning is a Continuous Bags-of-Words model.

13. The method as set forth in claim 10, wherein the deep learning module is a Skip Gram Model.

14. The method as set forth in claim 8, further comprising providing the top-k meaningful paths for use by a user.

15. The method as set forth in claim 8, wherein the data corpus comprises Wikipedia articles and the knowledge base is DBpedia.

16. A non-transitory computer readable medium having computer readable program for searching a knowledge base for finding top-k meaningful paths between concepts in linked open data in response to input concept pairs based on user request, comprising:
providing a data corpus containing concept pairs;
searching and extracting concepts and its context from the data corpus;
generating a vector representation for each extracted concept;
calculating the weight for each edge in a knowledge graph given an edge and using a vector representation from a precomputed concept vector model, calculating the weight of the edge for storage in a knowledge base with associated weights for each given edge;
calculating the top-k paths between a pair of input concepts using the knowledge base with associated weights;
providing the top-k shortest paths for use by a user.

17. The non-transitory computer readable medium as set forth in claim 16, where said generating a vector representation uses a neural network based language model.

18. The non-transitory computer readable medium as set forth in claim 16, further comprising learning a vector by deep learning a vector representing a concept vector model and the cosine similarity of the concept vector model and input concept vectors being the degree of association of each concept vector model and the input concept vector, the degree of association being the weight of the concepts.

19. The non-transitory computer readable medium as set forth in claim 16, where top-k meaningful paths are generated based on the weight of the concept pairs.

20. The non-transitory computer readable medium as forth in claim 16, further comprising providing top-k meaningful paths to a user.
